(19) United States
(12) Patent Application Publication
(10) Pub. No.: US 2023/0095233 A1
(43) Pub. Date: Mar. 30, 2023

(54) LEVER-TYPE CONNECTOR

(71) Applicant: SUMITOMO WIRING SYSTEMS, LTD., Mie (JP)

(72) Inventor: Naomichi KAWASHIMA, Mie (JP)

(21) Appl. No.: 17/798,272

(22) PCT Filed: Jan. 25, 2021
(86) PCT No.: PCT/JP2021/002404

§ 371 Date: Aug. 8, 2022

(30) Foreign Application Priority Data
Feb. 14, 2020 (JP) 2020-023108

(51) Int. Cl. H01R 13/629

(52) U.S. Cl. CPC H01R 13/62938

(57) ABSTRACT

The lever includes a cam plate portion. A cam groove to be engaged with a cam pin provided on the mating connector is provided to penetrate through the cam plate portion. A reinforcing rib is provided to cover the cam pin and extend over the cam groove near an entrance opening of the cam groove, into which the cam pin enters. The connector housing includes lever protection walls. The lever protection walls are provided to project from both side walls of the connector housing to come into contact with an outer edge part of the cam plate portion located outside the cam groove with respect to a rotary shaft when the lever is at the connection start position.

### TECHNICAL FIELD

The present disclosure relates to a lever-type connector.

### BACKGROUND

A lever-type connector is a connector connectable to a mating connector with a small force by a cam action, accompanying the rotation of a lever. Conventionally, a lever-type connector for waterproof is known in which a cam groove to be engaged with a cam pin of a mating connector is provided on an inner side of a lever in terms of strength as described in Japanese Utility Model Publication No. H06-062481 (Patent Document 1 below).

Further, a lever-type connector for waterproof in which a penetrating cam groove is formed is also known as described in Japanese Patent Laid-open Publication No. 2004-288500 (Patent Document 2 below).

### Prior Art Document

### Patent Document

Patent Document 1: JP H06-062481 U
Patent Document 2: JP 2004-288500 A

### SUMMARY OF THE INVENTION

### Problems to Be Solved

To form the cam groove on the inner side of the lever as in the lever-type connector described in Patent Document 1, it is necessary to use an inner slide mold and the number of mold cavities is reduced.

On the other hand, the lever formed with the penetrating cam groove as in the lever-type connector described in Patent Document 2 can be molded without using an inner slide mold, but is lower in strength than a non-penetration type lever having a cam groove formed on an inner side. Thus, there has been a problem that the cam groove is opened and the lever is easily broken, for example, if the lever is erroneously rotated in an incompletely connected state where the rotation of the lever cannot be started due to an insufficient insertion depth of the mating connector into the lever-type connector during a connecting operation.

The present disclosure was completed on the basis of the above situation and aims to provide a lever-type connector which can be molded without using an inner slide mold and in which a lever is unlikely to be broken.

### Means to Solve the Problem

The present disclosure is directed to a lever-type connector with a connector housing to be connected to a mating connector, and a lever to be assembled with the connector housing, the lever being rotatable from a connection start position to a connection end position, wherein the lever includes a cam plate portion, a cam groove to be engaged with a cam pin provided on the mating connector is provided to penetrate through the cam plate portion, a reinforcing rib is provided to cover the cam pin and extend over the cam groove near an entrance opening of the cam groove, the cam pin entering the cam groove, the connector housing includes lever protection walls, and the lever protection walls are provided to project from both side walls of the connector housing to come into contact with an outer edge part of the cam plate portion located outside the cam groove with respect to a rotary shaft when the lever is at the connection start position.

### Effect of the Invention

According to the present disclosure, it is possible to provide a lever-type connector which can be molded without using an inner slide mold and in which a lever is unlikely to be broken.

### BRIEF DESCRIPTION OF THE DRAWINGS

FIG. 1 is a perspective view of a connector housing according to an embodiment.

FIG. 2 is a perspective view of a lever according to the embodiment.

FIG. 3 is a front view of the lever according to the embodiment.

FIG. 4 is a side view showing a state where the lever is at a connection start position in a lever-type connector according to the embodiment.

FIG. 5 is a section along A-A in FIG. 4.

FIG. 6 is a section along B-B in FIG. 4.

FIG. 7 is a side view showing an incompletely connected state where a mating connector is shallowly connected to the lever-type connector according to the embodiment.

FIG. 8 is a section along C-C in FIG. 7.

FIG. 9 is a side view showing a state where the connection of the lever-type connector according to the embodiment and the mating connector is completed and the lever is at a connection end position.

FIG. 10 is a section along D-D in FIG. 9.

FIG. 11 is a plan view showing a state where the lever is at the connection end position in the lever-type connector according to the embodiment.

FIG. 12 is a section along E-E in FIG. 11.

### DETAILED DESCRIPTION TO EXECUTE THE INVENTION

### Description of Embodiments of Present Disclosure

First, embodiments of the present disclosure are listed and described.

(1) The lever-type connector of the present disclosure is provided with a connector housing to be connected to a mating connector and a lever to be assembled with the connector housing, the lever being rotatable from a connection start position to a connection end position, wherein the lever includes a cam plate portion, a cam groove to be engaged with a cam pin provided on the mating connector is provided to penetrate through the cam plate portion, a reinforcing rib is provided to cover the cam pin and extend over the cam groove near an entrance opening of the cam groove, the cam pin entering the cam groove, the connector housing includes lever protection walls, and the lever protection walls are provided to project from both side walls of the connector housing to come into contact with an outer edge part of the cam plate portion located outside the cam groove with respect to a rotary shaft when the lever is at the connection start position.

According to this configuration, since the reinforcing rib can suppress the opening of the cam groove from the vicinity of the entrance opening, the strength of the lever can be improved. Further, since the lever protection wall can come into contact with and hold the outer edge part of the cam plate portion, the lever is unlikely to be broken.

(2) Preferably, the lever protection wall is provided to extend and come into contact with the outer edge part of the cam plate portion from the vicinity of the entrance opening of the cam groove toward a back side when the lever is at the connection start position, and the reinforcing rib and the lever protection wall suppress deformation of the outer edge part of the cam plate portion in a direction away from the rotary shaft when a force is applied to rotate the lever in an incompletely connected state where rotation of the lever toward the connection end position is hindered by the cam pin due to an insufficient insertion depth of the mating connector into the lever-type connector.

According to this configuration, in operating the lever in the incompletely connected state, the lever protection wall can more effectively receive a force applied to the outer edge part of the cam plate portion.

(3) Preferably, the reinforcing rib is provided to extend in a connecting direction of the mating connector and the connector housing.

According to this configuration, since the reinforcing rib can be molded by removing a mold in the connecting direction of the mating connector and the connector housing without using an inner slide mold, the strength of the lever can be improved without complicating the mold.

### Details of Embodiment of Present Disclosure

Hereinafter, an embodiment of the present disclosure is described. The present invention is not limited to these illustrations and is intended to be represented by claims and include all changes in the scope of claims and in the meaning and scope of equivalents.

### Embodiment

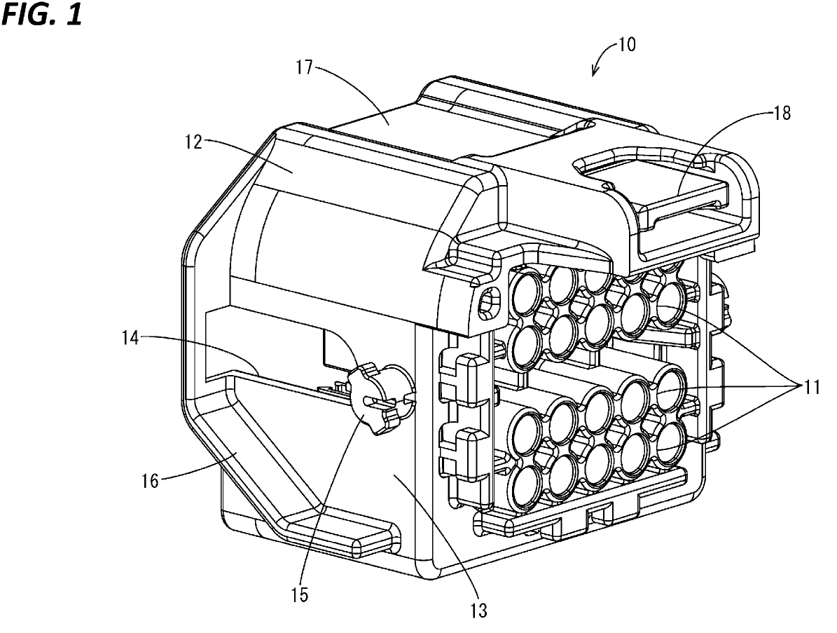

The embodiment of the present disclosure is described with reference to FIGS. 1 to 12.

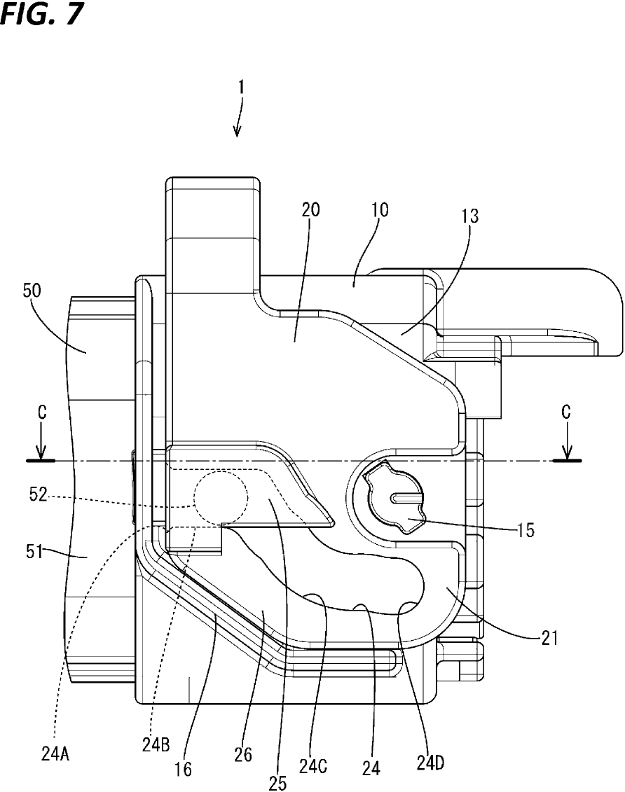

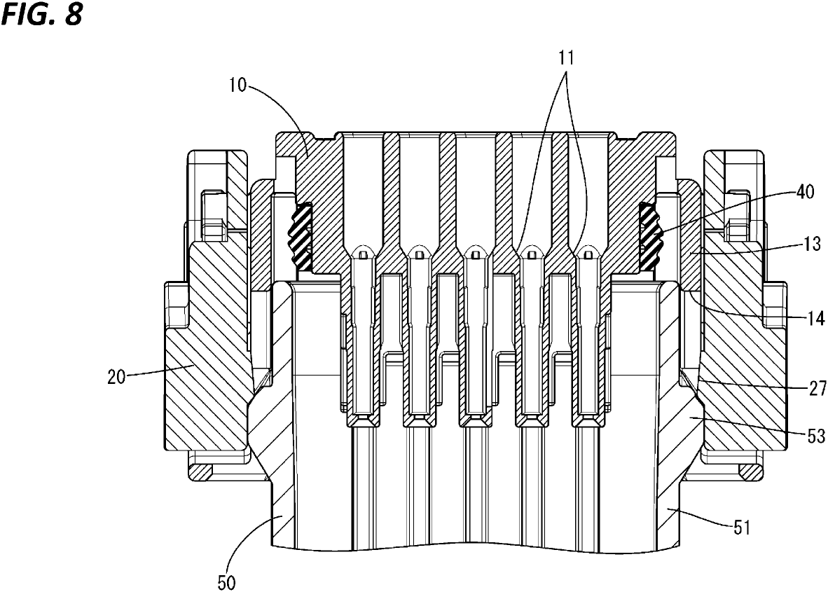

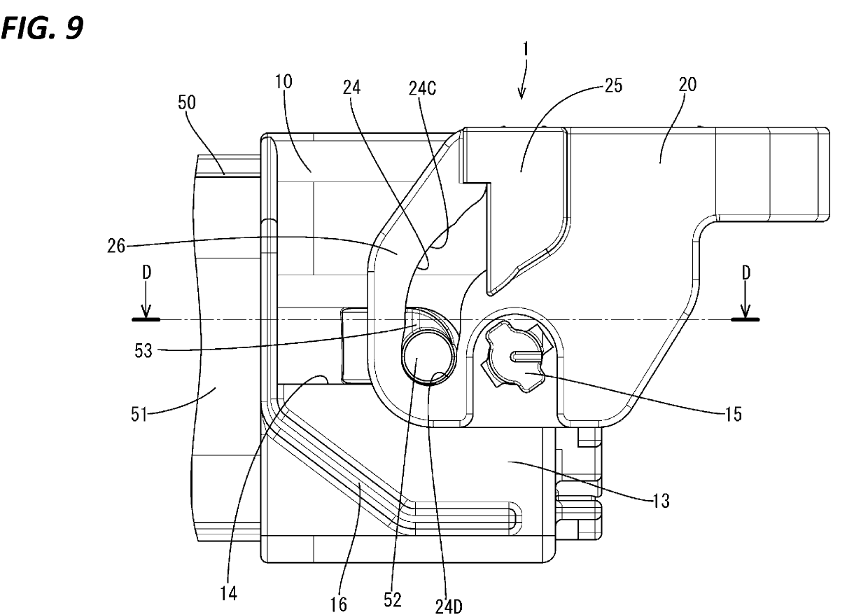

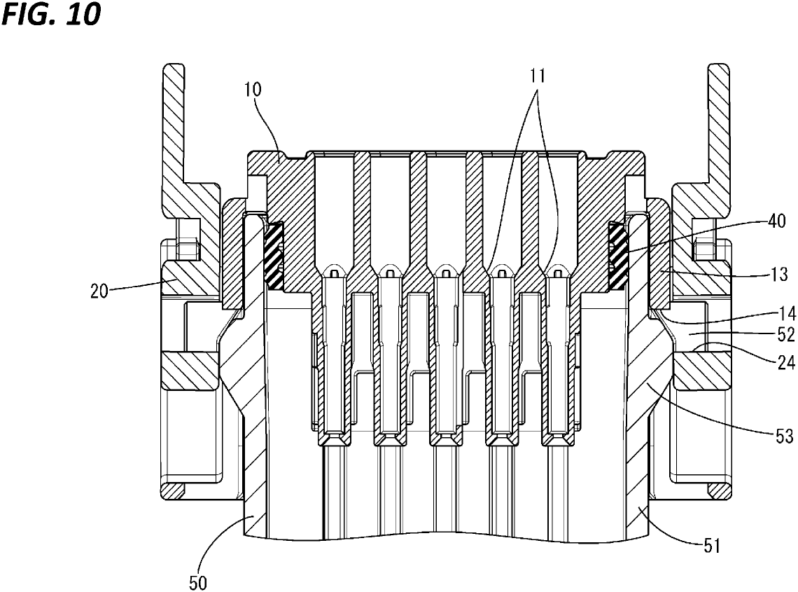

A lever-type connector 1 of this embodiment includes a connector housing 10 and a lever 20 to be assembled with the connector housing 10. As shown in FIGS. 7 and 9, the lever-type connector 1 is connectable to a mating connector 50. The lever-type connector 1 includes a sealing member 40 to be mounted inside the connector housing 10. As shown in FIGS. 8 and 10, the lever-type connector 1 is a waterproof connector for waterproofing the inside of the connector housing 10 by sandwiching the sealing member 40 between the mating connector 50 and the lever-type connector 1.

As shown in FIG. 9, the mating connector 50 includes a mating receptacle 51, a pair of cam pins 52 projecting from outer surfaces of the mating receptacle 51 and a pair of projecting portions 53 located above (above in FIG. 9) the pair of cam pins 52 and projecting from the outer surfaces of the mating receptacle 51. Male terminals (not shown) are accommodated inside the mating connector 50.

The connector housing 10 is made of synthetic resin and includes, as shown in FIG. 1, terminal accommodating portions 11 and a receptacle 12 in the form of a rectangular tube surrounding the terminal accommodating portions 11. A female terminal (not shown) connected to an end of a wire is accommodated into the terminal accommodating portion 11. The receptacle 12 has a pair of side walls 13 disposed to face each other in a lateral direction. The pair of side walls 13 are disposed in parallel to each other.

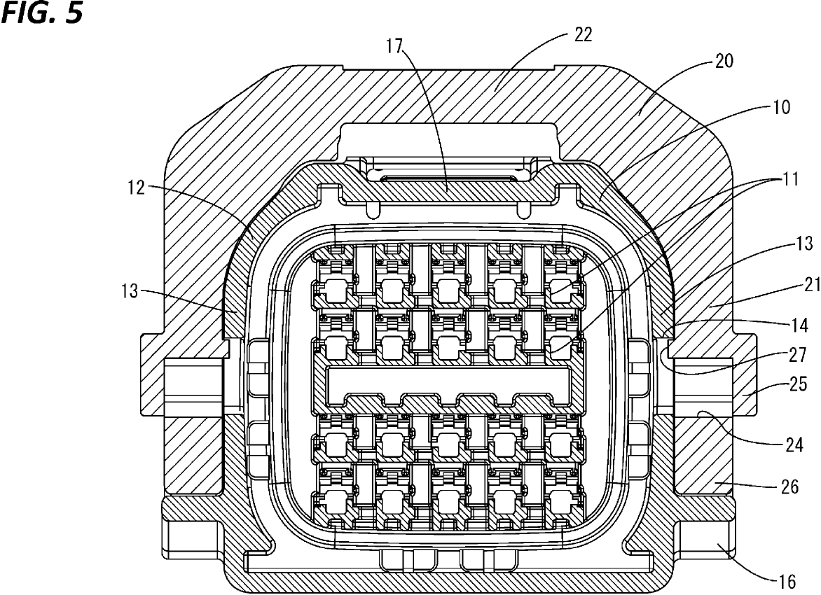

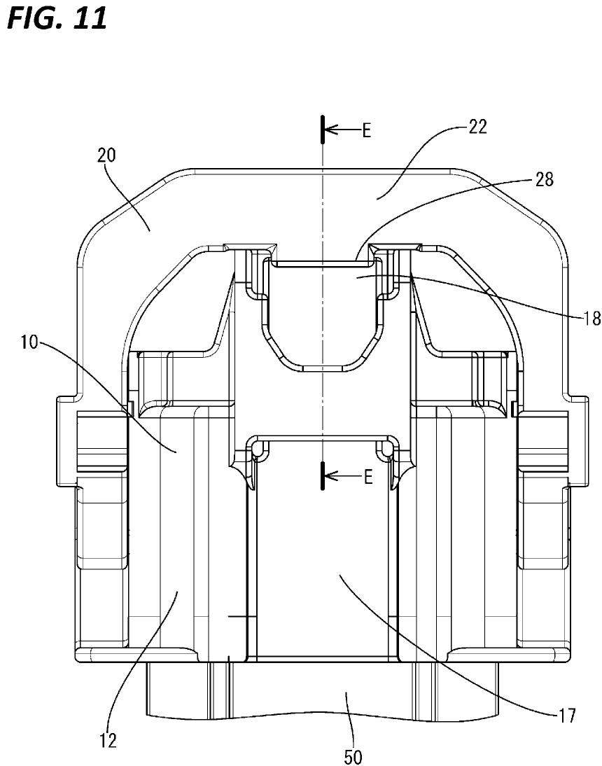

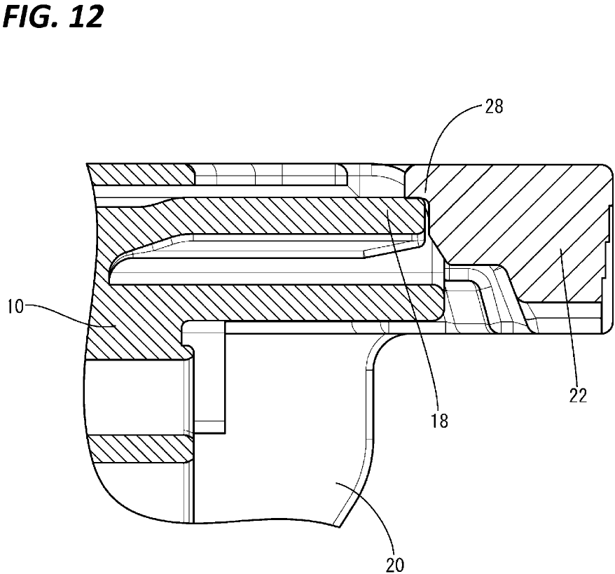

As shown in FIGS. 1 and 5, the side wall 13 includes a guide groove 14 for receiving the cam pin 52 and the projecting portion 53 of the mating connector 50. As shown in FIG. 1, a pair of rotary shafts 15 for rotatably supporting the lever 20 are provided to project on the pair of side walls 13. A lever protection wall 16 is provided to project below (below in FIG. 1) the guide groove 14 on the side wall 13. As shown in FIG. 11, a lock receiving portion 18 is provided to project rearward (upward in FIGS. 11 and 12) on a ceiling wall on an upper side (side forward of the plane of FIG. 11) of the receptacle 12.

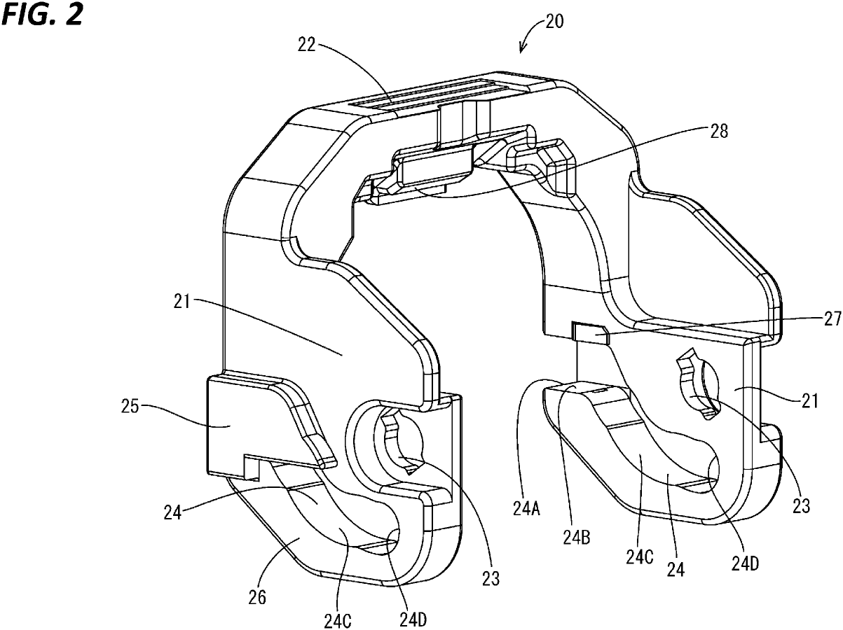

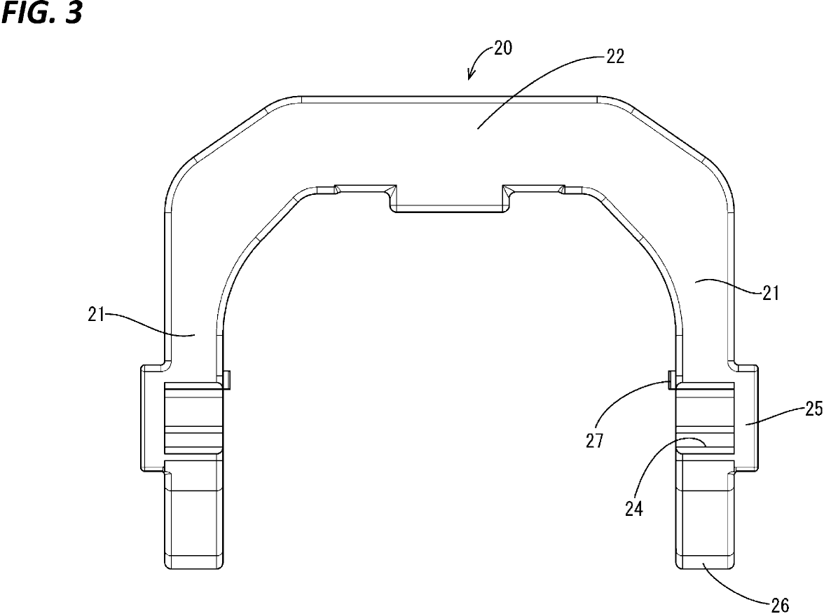

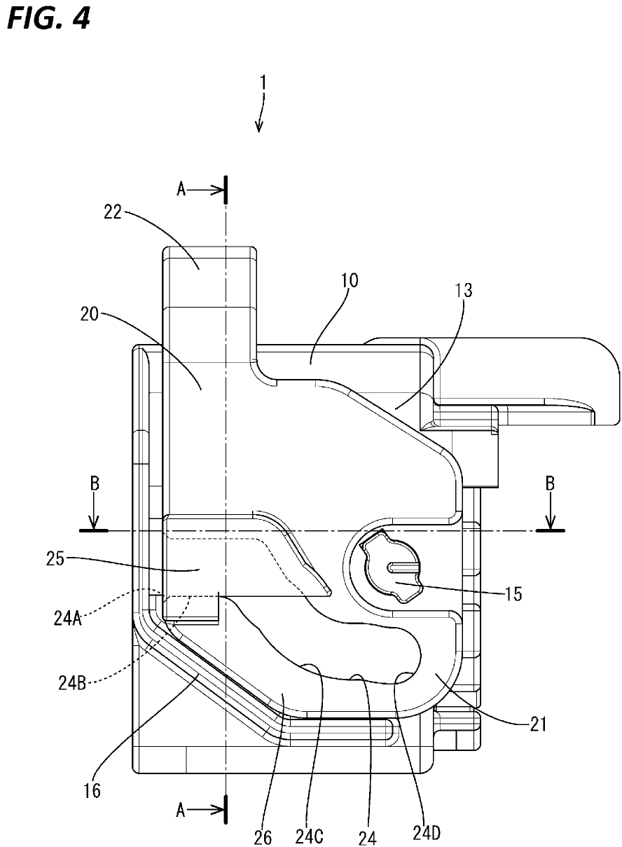

The lever 20 is made of synthetic resin and includes, as shown in FIGS. 2 and 3, a pair of cam plate portions 21 and a rotating portion 22 coupling the pair of cam plate portions 21. The pair of cam plate portions 21 are arranged in parallel to face each other and, as shown in FIGS. 4 and 5, mounted on the pair of side walls 13 to sandwich the connector housing 10.

As shown in FIG. 2, the cam plate portion 21 includes a bearing hole 23 for receiving the rotary shaft 15 and a cam groove 24 for receiving the cam pin 52. The cam groove 24 is formed to penetrate through the cam plate portion 21 in a plate thickness direction. An entrance opening 24A for allowing the entrance of the cam pin 52 is provided on the front edge of the cam plate portion 21 to be open forward. The cam groove 24 includes a straight portion 24B extending straight backward from the entrance opening 24A. The straight portion 24B is formed to extend in a connecting direction of the mating connector 50 and the connector housing 10. The cam groove 24 includes an arcuate engaging portion 24C gradually approaching the bearing hole 23, which is a center of rotation of the cam plate portion 21, from a back end part of the straight portion 24 further toward the back side. The engaging portion 24C extends up to a backmost part 24D of the cam groove 24.

As shown in FIG. 4, a reinforcing rib 25 is provided to extend over the cam groove 24 in a region of the cam plate portion 21 backward of the entrance opening 24A. As shown in FIG. 3, the reinforcing rib 25 is provided to extend in the connecting direction of the mating connector 50 and the connector housing 10, similarly to the straight portion 24B, and can be molded by removing a mold forward (forward of the plane of FIG. 3).

The lever 20 of the lever-type connector 1 is at a position shown in FIG. 4 (hereinafter, referred to as a connection start position) with respect to the connector housing 10 before connection to the mating connector 50, and reaches a position shown in FIG. 9 (hereinafter, referred to as a connection end position) with respect to the connector housing 10 when connection to the mating connector 50 is completed.

When the lever 20 is at the connection start position, the lever protection walls 16 of the connector housing 10 are in contact with outer edge parts 26 of the cam plate portions 21 located outside the cam grooves 24 with respect to the rotary shafts 15 as shown in FIGS. 4 and 5. The lever protection walls 16 are in contact with the outer edge parts 26 from the vicinity of the entrance openings 24A to the vicinity of the backmost parts 24D.

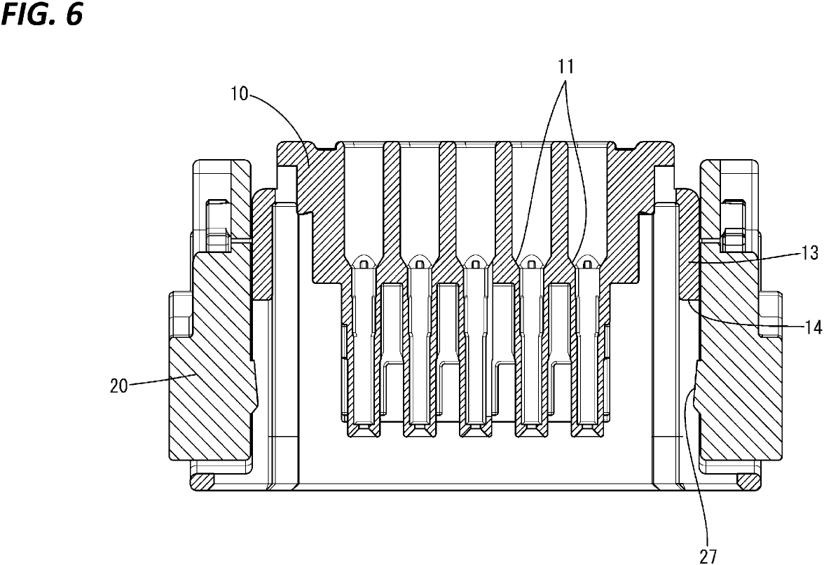

As shown in FIG. 5, a pair of locking projections 27 are provided to project on a pair of inner side surfaces of the cam plate portions 21 facing the connector housing 10. As shown in FIGS. 2 and 3, the locking projections 27 are provided closer to the rotating portion 22 than the straight portions 24B. As shown in FIGS. 5 and 6, the locking projections 27 are disposed to enter the guide grooves 14 of the connector housing 10. The lever 20 is held at the connection start position by the locking of the locking projections 27 and the inner walls of the guide grooves 14.

As shown in FIG. 2, the rotating portion 22 is provided with a lock portion 28 between the two cam plate portions 21. As shown in FIGS. 11 and 12, the lock portion 28 is disposed to be locked to the lock receiving portion 18 provided in the connector housing 10 at the connection end position.

### Connection of Lever-Type Connector and Mating Connector

In connecting the lever-type connector 1 to the mating connector 50, the mating connector 50 is relatively pulled toward the connector housing 10 by a cam action resulting from the engagement of the engaging portions 24C of the cam grooves 24 and the cam pins 52 as the lever 20 is rotated from the connection start position to the connection end position, whereby a connecting operation to the mating connector 50 is assisted.

First, with the lever 20 held at the connection start position, the mating connector 50 is inserted into the lever-type connector 1 and the cam pins 52 enter the cam grooves 24 through the entrance openings 24A. At this time, the cam pins 52 and the projecting portions 53 enter the guide grooves 14. If an insertion depth of the mating connector 50 into the connector housing 10 is insufficient and the cam pins 52 do not reach positions behind the straight portions 24B as shown in FIG. 7, the rotation of the lever 20 toward the connection end position is hindered by the cam pins 52. Further, as shown in FIG. 8, the projecting portions 53 are not pressed into contact with the locking projections 27 and the locking of the locking projections 27 and the inner walls of the guide grooves 14 is maintained as before the connection (FIG. 6). This state is referred to as an incompletely connected state below.

By inserting the mating connector 50 further to the back of the lever-type connector 1 from the incompletely connected state shown in FIGS. 7 and 8, the cam pins 52 reach the engaging portions 24C of the cam grooves 24 from the straight portions 24B. Further, the projecting portions 53 are pressed into contact with the locking projections 27 and push the locking projections 27 to outside the guide grooves 14, whereby the locking of the locking projections 27 and the inner walls of the guide grooves 14 is released.

Subsequently, the lever 20 is rotated from the connection start position to the connection end position. According to the rotation of the lever 20, the connector housing 10 is relatively pulled toward the mating connector 50 by a cam action based on the engagement of the cam pins 52 and the cam grooves 24.

When the cam pins 52 reach the backmost parts 24D of the cam grooves 24 and the lever 20 reaches the connection end position, the connector housing 10 reaches a proper connection position with respect to the mating connector 50 as shown in FIG. 9. At this time, as shown in FIG. 12, the lock portion 28 is locked to the lock receiving portion 18. Further, as the lever-type connector 1 and the mating connector 50 are connected, a space in which the female and male terminals are connected is sealed by the sealing member 40 mounted to surround the plurality of terminal accommodating portions 11 inside the connector housing 10, and waterproofness is exhibited (see FIG. 10).

### Separation of Lever-Type Connector and Mating Connector

In separating the mating connector 50 from the lever-type connector 1, the mating connector 50 is relatively pulled apart from the connector housing 10 by a cam action based on the engagement of the engaging portions 24C of the cam grooves 24 and the cam pins 52 as the lever 20 is rotated from the connection end position to the connection start position, contrary to the above connection, whereby a separating operation from the mating connector 50 is assisted.

### Forcible Rotation of Lever in Incompletely Connected State

In the incompletely connected state shown in FIG. 7, if the lever 20 is forcibly rotated, a force in a direction opposite to a rotating direction is applied to the straight portions 24B on a lower side (lower side in FIG. 7) from the cam pins 52, whereby the outer edge parts 26 of the cam plate portions 21 are deformed in a direction away from the rotary shafts 15. In this way, the entrance openings 24A of the cam grooves 24 may be opened and the lever 20 may be broken. However, in the lever-type connector 1, the reinforcing ribs 25 are provided to extend over the cam grooves 24 near the entrance openings 24A and the lever protection walls 16 are in contact with the outer edge parts 26 of the cam plate portions 21. Thus, even in the case as described above, the deformation and breakage of the lever 20 can be prevented.

### Functions and Effects of Embodiment

The following functions and effects are achieved according to this embodiment.

The lever-type connector 1 according to this embodiment is provided with the connector housing 10 to be connected to the mating connector 50 and the lever 20 assembled with the connector housing 10 and rotatable from the connection start position to the connection end position, the lever 20 includes the cam plate portions 21, the cam grooves 24 to be engaged with the cam pins 52 provided on the mating connector 50 are formed to penetrate through the cam plate portions 21, the reinforcing ribs 25 are provided to cover the cam pins 52 and extend over the cam grooves 24 near the entrance openings 24A of the cam grooves 24 into which the cam pins 52 enter, the connector housing 10 includes the lever protection walls 16, and the lever protection walls 16 are provided to project from the both side walls 13 of the connector housing 10 to come into contact with the outer edge parts 26 of the cam plate portions 21 located outside the cam grooves 24 with respect to the rotary shafts 15 when the lever 20 is at the connection start position.

According to the above configuration, since the reinforcing ribs 25 can suppress the opening of the cam grooves 24 from the vicinities of the entrance openings 24A, the strength of the lever 20 can be improved. Further, since the lever protection walls 16 can come into contact with and hold the outer edge parts 26 of the cam plate portions 21, the lever 20 is unlikely to be broken.

In this embodiment, the lever protection walls 16 are provided to come into contact with the outer edge parts 26 of the cam plate portions 21 from the vicinities of the entrance openings 24A of the cam grooves 24 to the back side when the lever 20 is at the connection start position. If a force is applied to rotate the lever 20 in the incompletely connected state where the cam pins 52 hinder the rotation of the lever 20 toward the connection end position due to an insufficient insertion depth of the mating connector 50 into the connector housing 10, the reinforcing ribs 25 and the lever protection walls 16 suppress the outer edge parts 16 of the cam plate portions 21 from being deformed in the direction away from the rotary shafts 15.

According to the above configuration, in operating the lever 20 in the incompletely connected state, the lever protection walls 16 can more effectively receive a force applied to the outer edge parts 26 of the cam plate portions 21.

In this embodiment, the reinforcing rib 25 is provided to extend in the connecting direction of the mating connector 50 and the connector housing 10.

According to the above configuration, since the reinforcing rib 25 can be molded by removing a mold in the connecting direction of the mating connector 50 and the connector housing 10 without using an inner slide mold, the strength of the lever 20 can be improved without complicating the mold.

### Other Embodiments

(1) Although the lever-type connector 1 includes the sealing member 40 and is waterproof in the embodiment, there is no limitation to this. A lever-type connector may not be waterproof.
(2) Although the locking projections 27 and the inner walls of the guide grooves 14 are locked at the connection start position and the locking of the locking projections 27 and the inner walls of the guide grooves 14 is released by pressing the projecting portions 53 into contact with the locking projections 27 in the embodiment, there is no limitation to this and locking projections and projecting portions may not be provided.

### List of Reference Numerals

1: lever-type connector
10: connector housing
11: terminal accommodating portion
12: receptacle
13: side wall
14: guide groove
15: rotarty shaft
16: lever protection wall
17: ceiling wall
18: lock receiving portion
20: lever
21: cam plate portion
22: rotating portion
23: bearing hole
24: cam groove
24A: entrance opening
24B: straight portion
24C:engaging portion
24D: backmost part
25: reinforcing rib
26: ourter edge part
27: locking projection
28: lock portion
40: sealing member
50: mating connector
51: mating receptacle
52: cam pin
53: projecting portion

1. A lever-type connector, comprising:
a connector housing to be connected to a mating connector; and
a lever to be assembled with the connector housing, the lever being rotatable from a connection start position to a connection end position,
wherein:
the lever includes a cam plate portion,
a cam groove to be engaged with a cam pin provided on the mating connector is provided to penetrate through the cam plate portion,
a reinforcing rib is provided to cover the cam pin and extend over the cam groove near an entrance opening of the cam groove, the cam pin entering the cam groove,
the connector housing includes lever protection walls,
the lever protection walls are provided to project from both side walls of the connector housing to come into contact with an outer edge part of the cam plate portion located outside the cam groove with respect to a rotary shaft when the lever is at the connection start position, and
a distance between the lever protection wall and the rotary shaft decreases toward the rotary shaft in a connecting direction of the mating connector and the connector housing.

2. The lever-type connector of claim 1, wherein:
the lever protection wall is provided to extend and come into contact with the outer edge part of the cam plate portion from the vicinity of the entrance opening of the cam groove toward a back side when the lever is at the connection start position, and
the reinforcing rib and the lever protection wall suppress deformation of the outer edge part of the cam plate portion in a direction away from the rotary shaft when a force is applied to rotate the lever in an incompletely connected state where rotation of the lever toward the connection end position is hindered by the cam pin due to an insufficient insertion depth of the mating connector into the lever-type connector.

3. The lever-type connector of claim 1, wherein the reinforcing rib is provided to extend in the connecting direction of the mating connector and the connector housing.
